(19) United States
(12) Patent Application Publication
(10) Pub. No.: US 2024/0026664 A1
(43) Pub. Date: Jan. 25, 2024

(54) SANITARY FITTING DEVICE, SANITARY SYSTEM AND METHOD FOR OPERATING A SANITARY FITTING DEVICE

(71) Applicant: BLANCO GMBH + CO KG, Oberderdingen (DE)

(72) Inventors: Tobias TACK, Oberderdingen (DE); Thomas FUNKE, Eppingen (DE); Dennis SPAETH, Oberderdingen (DE); Mirko HAMANN, Güglingen (DE); Hartmut KELLER, Weingarten (DE)

(73) Assignee: BLANCO GMBH + CO KG, Oberderdingen (DE)

(21) Appl. No.: 18/265,522

(22) PCT Filed: Dec. 7, 2021
(86) PCT No.: PCT/DE2021/200243

§ 371 Date: Jun. 6, 2023

(30) Foreign Application Priority Data
Dec. 7, 2020 (DE) 10 2020 215 446.5
Apr. 20, 2021 (DE) 10 2021 203 934.0

(51) Int. Cl. E03C 1/046; E03C 1/044

(52) U.S. Cl. CPC E03C 1/046; E03C 1/044; E03C 2201/45

(57) ABSTRACT

The invention relates to a sanitary fitting device, comprising a sanitary fitting for delivering a fluid, treatment equipment for providing at least one kind of treated fluid, wherein the treatment equipment comprises one or more treatment components, and a central distribution device, which is at least connected with the treatment equipment, comprising an energy distribution component, which is designed to provide electrical energy for at least one treatment component of the treatment device and wherein the distribution device is designed to regulate the electrical total power of the entire electrical energy emitted by means of the central distribution device under a specified maximum total power, and/or a fluid distribution component for distributing fluid to at least one of the treatment components of the treatment device.

The invention relates to a sanitary fitting device, comprising a sanitary fitting for delivering a fluid and treatment equipment for providing at least one kind of a treated fluid, wherein the treatment equipment comprises one or more treatment components.

The invention further relates to a sanitary system having a sanitary fitting device.

The invention further relates to a method for operating a sanitary fitting device.

Although the present invention can be generally applied to any fluids, the present invention is explained in relation to water as a fluid.

Sanitary fittings have become known in the most diverse ways. Known sanitary fittings comprise, for example, a fitting body having at least one actuator for adjusting at least one property of a fluid flow conducted through the sanitary fitting. The property may be for example the flow volume of the fluid flow or the temperature of the fluid flow. In the case of known sanitary fittings, the fluid flow is, for example, mixed from a separate cold water and hot water flow by means of a mixer tap and conducted from there to an outlet.

To increase the functionality, a sanitary fitting device has become known, for example, from DE 10 2013 000 773 A1 or DE 10 2013 002 236 A1 having at least one first actuating element for temperature and/or quantity adjustment of mixed water and having a second actuating element for adjusting quantity of hot water. Mixed water and hot water are delivered here via a common outlet in the discharge of the fitting.

The provision of hot water is usually performed in a boiler or the like, which must be arranged in a base cabinet due to installation space. A long length from the boiler to the outlet of the sanitary fitting results from this. If, in addition to the heated water, water with another kind of treatment, for example, filtered water, is to be discharged, it is problematic that for one thing the electrical power that must be provided for the different components is high and that this may lead to an overload of the electrical line of a house installation usually secured with 16A in the interplay of different electrical consumers. Furthermore, the number of the available electrical outlets in the region of a sanitary fitting is usually extremely limited. Several electrical consumers are then usually connected via multiple sockets, which further reduces the installation space available in the base cabinet. It is also problematic that, due to a large number of consumers, corresponding devices, such as a boiler, may not be able to be operated with optimal power. This, in turn, necessitates increased installation space, since more water must be stored at a high temperature and cannot be produced instantaneously. At the same time, the water allocation to the individual components and the supply of the treated water is also costly and complicated, due to the limited installation space usually present.

From EP 0 766 048 A1, a technical installation having an electrical circuit breaker box and a unit for controlling the technical unit is shown. The disadvantage here is that such a device requires a great deal of installation space and also does not enable further water treatment types.

From US 2020/0277768 A1, a piece of sanitary furniture with integrated sink is shown, which comprises a modular design and, in addition to a water inlet connection, also provides a filter unit and an electrical connection. The disadvantage here is that the number of the electrical connections is extremely limited. Moreover, the functionality with respect to the provision of treated water is also limited, since only a filter device is present.

An object of the present invention is therefore to provide a sanitary fitting device and a sanitary system which enables a flexible use of several different fluid treatment components with a simultaneously efficient operation with a high degree of safety and reliability. A further object of the present invention is to provide an alternative sanitary fitting device and an alternative sanitary system.

In an embodiment, the present invention achieves the above-mentioned objects through a sanitary fitting device, comprising
a sanitary fitting for delivering a fluid,
treatment equipment for providing at least one kind of treated fluid, wherein the treatment equipment comprises one or more treatment components, and
a central distribution device, which is at least connected with the treatment equipment, comprising
an energy distribution component, which is designed to provide electrical energy for at least one treatment component of the treatment device and wherein the distribution device is designed to regulate the electrical total power of the entire electrical energy emitted by means of the central distribution device below a specified maximum total power, and/or
a fluid distribution component for distributing fluid to at least one of the treatment components of the treatment device.

In a further embodiment, the present invention achieves the above-mentioned objects through a sanitary system having a sanitary fitting device according to one of the claims 1-12, comprising a piece of sanitary furniture having an upper and a lower region, wherein an outlet and/or operating elements of the sanitary fitting are arranged in the upper region and the treatment device and in particular a mixed water device in the lower region.

In a further embodiment, the present invention achieves the above-mentioned objects through a method for operating a sanitary fitting device according to one of the claims 1-12, comprising the steps
Providing electrical power for at least one of the treatment components of the treatment device
Measuring the electrical power, which at least one treatment component receives,
Determining whether the electrical total power of the entire electrical energy emitted by means of the central distribution device lies below a specified maximum total power, and
If not, adapting the power provided through the distribution device of at least one treatment device, such that the specified total power is not exceeded and/or
If so, allocating electrical power for the at least one treatment component, to the extent the latter can be varied at a specified power interval at the demand of a demand device.

One of the advantages achieved is that the installation space can be used better overall, since separate power plugs for the components or for the devices, which are connected to the distribution device, can be dispensed with. A further possible advantage is that the cost for wiring can be reduced in total. A further possible advantage is that a power line with which the distribution device is connected, is not overloaded, so that a reliable operation of all devices or components is enabled.

The term “treated liquid” is to be understood in the broadest sense and relates in particular in the claims, preferably in the description, to liquids, preferably water in the form of tap water from a water supplier or the like, which tap water is additionally changed in its properties and/or in its composition and/or manner of treatment by a separate device. Thus, treated water can have, for example, a high temperature, so-called hot water having a temperature of more than 80 degrees Celsius, another degree of carbonization, in part another composition or the like than water originally provided by the water supplier. The term “treated liquid” is understood not to mean in particular warm or cold water or mixed water which is commonly provided by a water supplier to a single-family home or a multi-family home, and which may be adjusted in its temperature by way of a heater or the like.

The term “type of treatment” is to be understood in the broadest sense and relates in particular in the claims, preferably in the description, not only to the fundamental type of treatment of a fluid, in particular of a liquid, for example whether the water was carbonated or not, but rather also to the degree, the intensity or the concentration of the treatment, for example the intensity of the carbonization. Different types of treatment are thereby understood to mean different degrees of carbonization, for example “still water”, “medium” or “classic”. Different types of treatment are also understood to mean different temperatures of hot water, water filtered to varying degrees, different concentrations of flavoring additives or aromatizations, for example by means of granulate for coffee, tea or the like, different types of mineralization, and different concentrations of the same type of mineralization or the like. The term “type of treatment” also includes, in particular, “non-treatment”. Beyond this, the “type of treatment” also includes disinfection and/or sterilization of a fluid, so that a hygienically treated fluid is provided.

The term “fluid treatment device” or “treatment device” is to be understood in the broadest sense and relates, in particular in the claims, preferably in the description, not only to the provision of a treated fluid, but rather also comprises the provision of separate fluids, such as a supply device for providing a liquid or gaseous disinfectant or the like.

The term “piece of sanitary furniture” is to be understood in the broadest sense and relates, in particular in the claims, preferably in the description, not only to a self-standing piece of furniture or the like, but rather also comprises in particular base cabinets, upper cabinets or parts thereof.

The term “fluid” comprises both gaseous materials and liquid materials, as well as combinations thereof.

Further features, advantages and embodiments of the invention are described below or are disclosed therein.

According to a preferred embodiment, the distribution device is designed to measure the electrical power received from the respective treatment component of the treatment device and to regulate the individual electrical power for each treatment component in a specifiable individual power interval. An individually available power can thereby be provided optimally to the respective components, or a large number of possible components can be operated on the distribution device.

According to a further preferred embodiment, the distribution device is designed to regulate the power on demand from a demand device up to the upper limit of the power interval for a specifiable time for a device connected to the distribution device and/or for one or more of the treatment components, the individual power consumption of which can be varied at a specified power interval. A performance increase for individual components or devices can thereby be enabled, by these being able to be operated—if these are designed for a higher power—correspondingly with higher power—at least for a certain time. The formulation “on demand” is to be understood in the broadest sense and means, for example, that a user would like to tap hot water, for example by pressing a corresponding button which is present, operation of a user interface or the like. The formulation also means that the corresponding performance of a function is performed on demand if a certain state of the sanitary fitting device exists. For example, a rinsing function with hot water or the like is performed if water was previously output with flavoring or additives.

According to a further preferred embodiment, the distribution device comprises at least a communication interface which is designed for querying and/or receiving operational information, in particular comprising power information, from the treatment device, in particular individually from the respective treatment components. Operating of status information can thereby be made available in ongoing operation to the respective treatment component or the device, which for example enables the detection of a faulty operating state or the like.

According to a further preferred embodiment, the distribution device and at least the treatment device are designed for bidirectional communication with one another. A possible advantage here is that a particularly reliable operation is enabled, by for example the distribution device being able to check the operating state of the treatment device. Conversely, the component or the corresponding device may receive information, for example, via the available power from the distribution device or also request information for operation.

According to a further preferred embodiment, the communication interface is designed as a BUS interface or as an air interface. Not only a direct communication connection between a device and the distribution device may thereby be enabled, but rather also an indirect communication, by, for example, a hot water device being connected via a filter device, wherein the latter is connected with the distribution device for communication. Overall, the wiring cost is reduced or the installation of the device or the treatment component for communication with the distribution device is facilitated.

According to a further preferred embodiment, the distribution device comprises a second communication interface for connecting the sanitary fitting device to an extemal control/regulation system. One of advantages thereby possible is an increased flexibility in the control/regulation of the sanitary fitting device and an improved user experience.

According to a further preferred embodiment, the distribution device is designed to provide two different electrical voltages to the various outputs for providing electrical energy. One of advantages thereby possible is an increased flexibility in the selection of possible components or devices connecting to the distribution device.

According to a further preferred embodiment, at least one further device is arranged which is connected to the distribution device for providing electrical energy and which does not comprise a communication connection for the distribution connection. One of advantages thereby possible is an increased flexibility in the selection of possible components connecting to the distribution device.

According to a further preferred embodiment, the treatment device comprises at least one of the following devices:
a filter device for providing a filtered fluid, in particular filtered water,
a carbonization device for providing a carbonated fluid, in particular carbonated water,
a warming or heating device for providing fluids at a high temperature, in particular hot water,
a cooling device, in particular for providing a cooled fluid, in particular water,
an ionization device for ionizing a fluid, in particular water,
an enrichment device for enriching the fluid with at least one substance, in particular mineral substance, flavoring, dye or the like,
an additive device for adding concentrates, in particular fruit juice concentrates or the like, to a fluid,
a hygienic device for providing hygienically treated fluid, in particular for disinfecting a fluid, and/or
a cleaning device for providing a cleaning and/or rinsing medium in place of or adding to a liquid.

The hygienic device may thereby comprise, for example, a radiation device for providing UV light or the like, A large number of possible treatment types for fluids, in particular water, can thereby be provided. These may also be stored, so that a faster delivery is enabled with repeated selection of the respective treated fluid.

According to a further preferred embodiment, the warming and/or heating device and/or cooling device and/or the hygienic device can each be operated at a specified power interval. One of the advantages thereby possible is a flexible control or energy supply as needed. If, for example, a user demands the tapping of hot water, the heating device can quickly provide increased power, in order to be able to deliver hot water in a larger quantity. The heating device of the boiler may have correspondingly smaller dimensions.

According to a further preferred embodiment, the distribution device and at least the treatment device are connected to one another by wiring or wirelessly for in particular encrypted communication. A possible advantage here is that devices to be connected in a flexible manner may be connected for communication to the distribution device. If the communication is encrypted, security with respect to possible manipulation is increased.

According to a further preferred embodiment of the sanitary system, the central distribution device is arranged in the lower region in the center and adjacent to the upper region. A possible advantage is a simple availability and a simple assembly of the further devices.

Other important features and advantages of the invention result from the dependent claims, from the drawings and the corresponding description of the figures using the drawings.

It is understood that the above-mentioned features, and features yet to be explained below, may be used not only in the respectively indicated combination, but rather also in other combinations or alone, without departing from the scope of the present invention.

Preferred designs and embodiments of the invention are presented in the drawings and explained further in the description below, wherein identical reference numerals refer to identical or similar or functionally similar components or elements.

In the drawings,

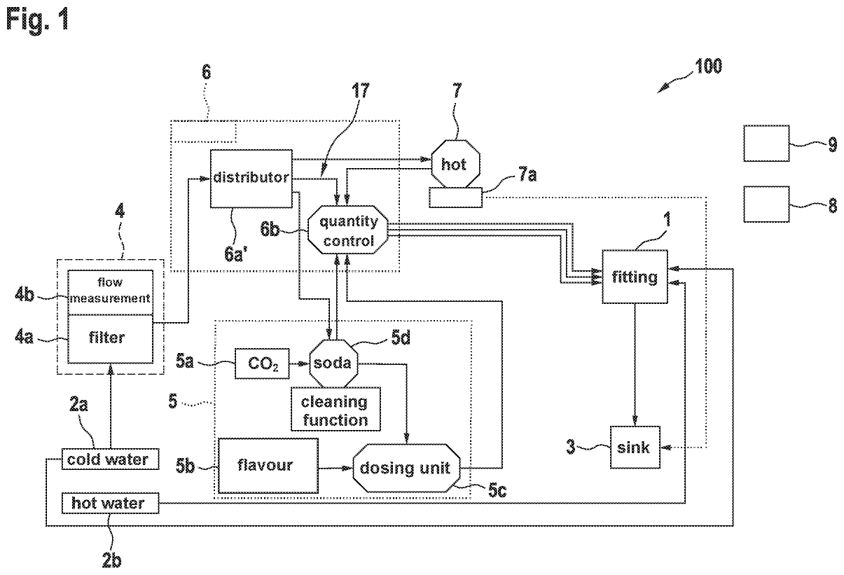

FIG. 1 shows a fitting of a sanitary system according to an embodiment of the present invention;

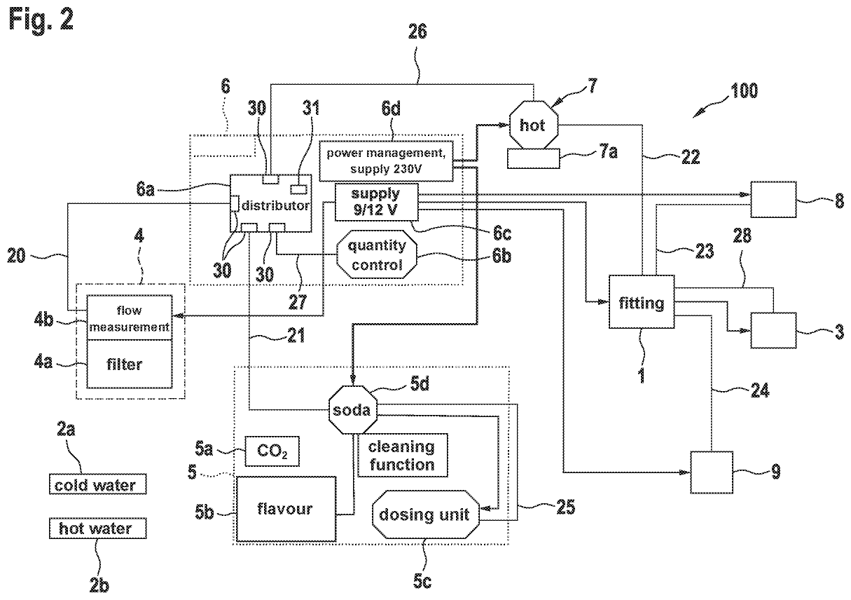

FIG. 2 shows a diagram of the electrical connections of the sanitary system according to FIG. 1:

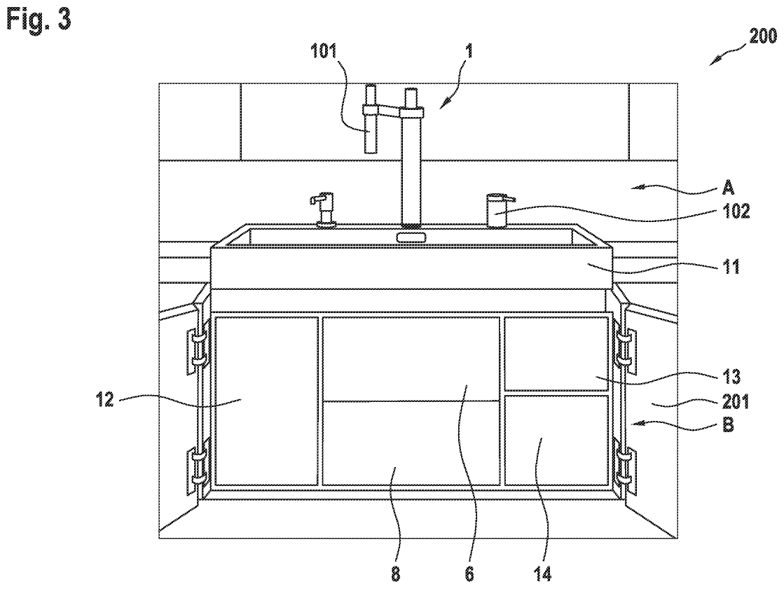

FIG. 3 shows a sanitary fitting system according to an embodiment of the present invention; and

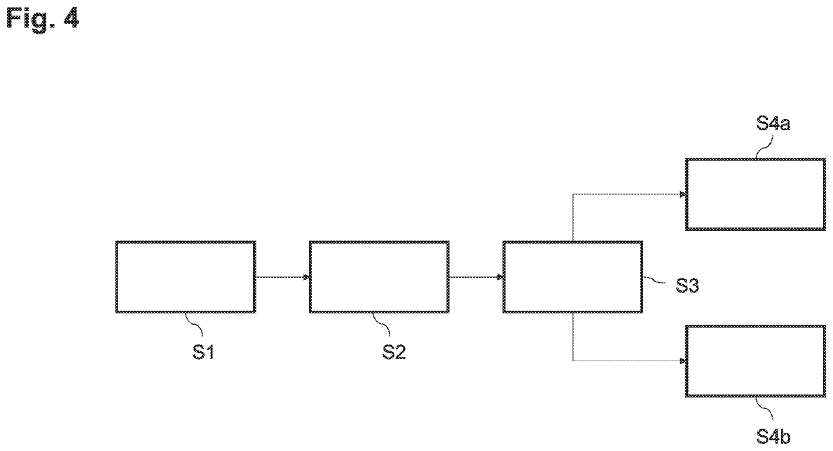

FIG. 4 shows steps of a method according to an embodiment of the present invention.

FIG. 1 shows a water course diagram of a sanitary system according to an embodiment of the present invention.

FIG. 1 shows in detail a sanitary system 100. The sanitary system 100 comprises a fitting 1 for delivering water into a sink 3. The sanitary system 100 further comprises a cold water connection 2a and a hot water connection 2b, on the one hand to be able to deliver mixed water via the fitting 1, which comprises a mixed water battery, and on the other hand the cold water connection 2a is also connected to a filter device 4, comprising a filter 4a and a flow measurement device 4b. The filter 4a serves to filter the cold water, for example, with respect to impurities or the like. The flow measurement device 4b serves to measures the flow of filtered water and to display a change of filter when a specified value is exceeded. The filter device 4 is connected downstream with a distribution device 6, comprising a water distributor 6a′, which is separately connected to a flavoring device 5 for adding flavor concentrates and a hot water device 7 for providing hot water. The flavoring device 5 comprises a CO₂ cartridge 5a, a soda component 5d with cleaning function, which is connected with a dosing unit 5c, and a flavor-adding component 5b, which also is connected to the dosing unit 5c. The dosing unit 5c and also the soda component 5d are in turn connected to a quantity control unit 6b or the distribution device 6. The flavoring device 5 here comprises in addition to the actual flavor-adding component 5b with dosing unit 5c, the soda component 5d including CO₂ cartridge 5a as well. These may, however, also be arranged separately from one another in separate devices.

The hot water device 7 comprises a safety valve 7a, which opens automatically at a correspondingly high pressure, and a direct connection to the sink 3. Damage to the hot water device 7 is thereby avoided. The hot water device 7 is also connected with the quantity control unit 6b. The quantity control unit 6b controls the delivery of treated water, so here soda, filtered water, water with flavoring or hot water, as a function of user specification, for examples through a user interface 9, and is fluidically connected with the fitting 1 via one or more lines.

Optionally,—as shown in FIG. 1, reference numeral 17—there may be a direct fluid connection from distributor 6a′ to the quantity control unit 6b, in order to be able to deliver filtered water via the flavoring device 5.

On the one hand, the already mentioned user interface 9 and an additional electrical consumer 8, such as an electrically operated waste bucket, an electrically operated crusher, a rinsing machine, an odor suppression device or the like, are not included in the water course diagram.

FIG. 2 shows a diagram of the electrical connections of the sanitary system according to FIG. 1. FIG. 2 shows in detail the sanitary system 100 according to FIG. 1 with the respective components. The cold water connection 2a and the hot water connection 2b, are not included in the diagram 2, as these do not need to be supplied with electrical energy.

The distribution device 6 here comprises an electrical distributor 6a, which is designed for providing electrical energy. For this, the distribution device 6 comprises on the one hand a high voltage interface 6d for providing electrical energy having a voltage of 230V and on the other hand a low voltage interface 6c for providing electrical energy having a voltage of 9 and/or 12 and/or 24 volts or the like.

Furthermore, the distribution device 6 comprises one or more communication interfaces 30 for communication of the distribution device 6 with the hot water device 7, the flavoring device 5, the flow measuring device 4b, the filter device 4 and the quantity control unit 6b via connections 26, 21, 20, 27. The communication is done here based on a BUS system, so that a device may also be connected to the distribution device 6 via one or more additional devices, which device is connected to the distribution device 6. In FIG. 2, this relates to the fitting 1, which is connected via the hot water device 7 with the distribution device 6, reference numeral 22. With fitting 1, the user interface 9, connection 24, the sink 3, connection 28 and the additional electrical consumer 8, connection 23, are in turn connected for communication with the distribution device 6. In the flavoring device 5, the flavoring additive component 5b is in turn connected to the soda component 5d for communication, reference numeral 21, wherein this is in turn connected to the dosing unit 5c for communication, reference numeral 25.

With the high voltage interface 6d of the distribution device 6, the hot water device 7 and the flavoring device 5, in particular the soda component 5d, are connected.

The soda component 5d in turn provides a low voltage interface (not shown) for supplying energy to the dosing unit 5c.

With the low voltage interface 6c of the distribution device 6, the additional electrical consumer 8 and the fitting 1, and via the fitting 1 the sink 3. With the low voltage interface 6c, the user interface 9 and the flow measuring device 4b of the filtering device 4 are furthermore directly connected.

The distribution device 6 according to embodiments of the invention thereby provides a central distribution of water as well as electrical energy for the connected components, devices and additional consumers. It also enables monitoring or control via corresponding communication interfaces 30. Via its own one- or two-directional communication interface 31, which is preferably designed to be wireless, a connection of the distribution device 6 to an external system, for example as part of a home automation system, is possible. Furthermore, the communication may take place via the communication interfaces 30, 31—as when designed wireless—and/or wired, respectively by means of Bluetooth, WLAN, power LAN or other protocols, standards or the like.

In other words, the distribution device 6 provides electrical energy for the devices 4, 5, 7 and for the fitting 1 together with the components and units connected thereto. The supply of electrical energy is done in such a way that the electrical total power of the entire electrical energy emitted by means of the central distribution device 6 remains below a specified maximum total power. This thereby prevents the electrical grid, for example via an outlet or a house network with which the distribution device 6 is connected, from being overloaded. The distribution device 6 ensures that the maximum power utilized—specified by the electrical system—is not exceeded. This thereby prevents the electrical circuit breaker of the respective living unit or house from being triggered. Here it is also possible to allocate a higher electrical power to individual components, so that these work with a higher performance, for example the hot water device 7, which may warm a defined quantity of water at higher power values. The respective boiler for a respective quantity of hot water drawn may be designed smaller with regard to the installation space required.

The components or devices involved communicate here with the distribution device 6, in order to guarantee disruption-free operation with a change in the electrical power available and thereby to prevent the latter from going into an undefined system state and/or simply “crashing”.

But it is possible to also include consumers, device or components which may require or provide no communication with the distribution device 6. These electrical consumers are monitored by the distribution device 6 according to the current power consumption. The communicating devices integrated in the sanitary system 100 may then effectively use the electrical power still available. The reaction time in case of a direct increase in the required power is sufficient in order to realize the intervention into the total electrical power, without activating the respective electrical circuit breaker. Short spikes in power are thereby buffered without a power interruption.

These circuit breakers provided in a house installation are generally sluggish enough that sufficient time remains for a power reduction for individual components and devices and that no circuit breaker is triggered.

FIG. 3 shows a sanitary fitting system schematically according to one embodiment of the present invention.

In FIG. 3, a sanitary fitting system 200 is shown comprising a sink 11 having a fitting 1 with outlet 101 and operating elements 102. These are arranged above (reference sign A) a cabinet 201 with a work surface. In the lower region B, so below the kitchen work surface, water connections and pipes 12 are arranged in a manner shown schematically. The electrical wiring together with the distribution device 6 is arranged in the top center, and a waste bucket 8 is arranged underneath. Next to it on the right, water treatment modules 14, for example for the provision of hot water, soda and the like, are arranged, and connections and wiring 13 for the modules mentioned above them. The distribution in the lower region B shown schematically in FIG. 3 can also be done differently. In general, in an embodiment of the present invention, one or more components, devices, consumer or the like may be designed as modules, which can be fixed to one another and/or to a frame and/or to the cabinet 201, in particular in a detachable manner. The modules or parts of this may be arranged or designed to be interchangeable.

FIG. 4 shows steps, schematically, of a method according to an embodiment of the present invention.

FIG. 4 shows in detail the steps of a method for operating a sanitary fitting device according to one of the claims 1-12. Here the following steps are performed:
Providing S1 electrical power for at least one of the treatment components of the treatment device,
Measuring S2 the electrical power which receives at least one processing component,
Determining S3 whether the electrical total power of the entire electrical energy emitted by means of the central distribution device lies below a specified maximum total power, and
If not, adapting S4a the power provided through the distribution device of at least one treatment device, such that the specified total power is not exceeded and/or
If so, allocating S4b more electrical power for at least one treatment component, to the extent the latter can be varied at a specified power interval at the demand of a demand device.

In summary, the present invention provides at least one of the following features and/or at least one of the following advantages:
Central energy supply.
Lower wiring cost.
Reliable operation or more reliable control.
Less installation space for individual components.
Flexible control.
Flexible use of various components.
Simple, cost-effective implementation.

Although the present invention was described using preferred embodiments, it is not limited to these, but rather may be modified in various ways.

### LIST OF REFERENCE NUMERALS

1 Sanitary fitting
2a, 2b Cold/hot water connection in house
3 Sink
4 Filter device
4a Filter
4b Flow measuring device
5 Treatment device
5a CO₂ cartridge
5b Flavoring additive component
5c Dosing unit
5d Soda component
6 Distribution device
6a Energy distribution component
6a′ Fluid distribution component
6b Quantity control unit
6c, 6d Electrical outputs
7 Hot water device
7a Safety valve
8 Waste bucket
9 Demand device/user interface
11 Sink
12 Water connection or pipes
13 Wiring
14 Water treatment modules
17 Fluid connection (optional)
20 Communication connection
21 Communication connection
22 Communication connection
23 Communication connection
24 Communication connection
25 Communication connection
30 Communication interface
31 Communication interface
100 sanitary fitting device
101 Outlet
102 Operating element
200 Sanitary system
201 Sanitary fumiture
A Upper region
B Lower region
S1, S2, S3, S4a, S4b Method steps

1. Sanitary fitting device (100), comprising
a sanitary fitting (1) for delivering a fluid,
treatment equipment (5, 7) for providing at least one kind of a treated fluid, wherein the treatment equipment (5) comprises one or more treatment components (5a, 5b, 5c, 5d, 7), and
a central distribution device (6), which is at least connected with the treatment equipment (5, 7), comprising
an energy distribution component (6a), which is designed to provide electrical energy for at least one treatment component (5a, 5b, 5c, 5d, 7) of the treatment device (5, 7) and wherein the distribution device (6) is designed to regulate the electrical total power of the entire electrical energy emitted by means of the central distribution device (6) under a specified maximum total power, and/or
a fluid distribution component (6a′) for distributing fluid to at least one of the treatment components (5a, 5b, 5c, 5d, 7) of the treatment device (5, 7).

2. Sanitary fitting device (100) according to claim 1, characterized in that the distribution device (6) is designed to measure the electrical power received from the respective treatment component (5a, 5b, 5c, 5d, 7a) of the treatment device (5, 7) and to regulate the individual electrical power for each treatment component (5a, 5b, 5c, 5d, 7) at a specifiable individual power interval.

3. Sanitary fitting device (100) according to claim 1, characterized in that the distribution device (6) is designed to regulate the power on demand from a demand device (9) up to the upper limit of the power interval for a specifiable time for a device (5, 7) connected to the distribution device (6) and/or for one or more of the treatment components (5a, 5b, 5c, 5d, 7), the individual power consumption of which can be varied at a specified power interval.

4. Sanitary fitting device (100) according to claim 1, characterized in that the distribution device (6) comprises at least one communication interface (30) which is designed for querying and/or receiving operational information, in particular comprising power information, from the treatment device (5, 7), in particular individually from the respective treatment components (5a, 5b, 5c, 5d, 7).

5. Sanitary fitting device according to claim 1, characterized in that the distribution device (6) and at least the treatment device (5, 7) are designed for bidirectional communication with one another.

6. Sanitary fitting device (100) according to claim 4, characterized in that the communication interface (30) is designed as a BUS interface or air interface.

7. Sanitary fitting device (100) according to claim 1, characterized in that the distribution device (6) comprises a second communication interface (31) for connecting the sanitary fitting device (100) to an external control/regulation system.

8. Sanitary fitting device (100) according to claim 1, characterized in that the distribution device (6) is designed to provide two different electrical voltages to the various outputs (6c, 6d) for providing electrical energy.

9. Sanitary fitting device (100) according to claim 1, characterized in that at least one further device (8) is arranged which is connected to the distribution device (6) for providing electrical energy and which does not comprise a communication connection for the distribution device (6).

10. Sanitary fitting device (100) according to claim 1, characterized in that the treatment device (5, 7) comprises at least one of the following devices:
a filter device (4) for providing a filtered fluid, in particular filter water,
a carbonization device (5d) for providing a carbonated fluid, in particular carbonated water,
a warming or heating device (7) for providing fluids at a high temperature, in particular hot water,
a cooling device, in particular for providing a cooled fluid, in particular water,
an ionization device for ionizing a fluid, in particular water,
an enrichment device for enriching the fluid with at least one substance, in particular mineral substance, flavoring, dye or the like,
an additive device (5b, 5c) for adding concentrates, in particular fruit juice concentrates or the like, to a fluid,
a hygienic device for providing hygienically treated fluid, in particular for disinfecting a fluid, and/or
a cleaning device for providing a cleaning and/or rinsing medium in place of or adding to a liquid.

11. Sanitary fitting device (100) according to claim 3, characterized in the warming and/or heating device and/or cooling device (7) and/or the hygienic device can each be operated at a specified power interval.

12. Sanitary fitting device (100) according to claim 4, characterized in that the distribution device (6) and at least the treatment device (5, 7) are connected to one another by wiring or wirelessly for in particular encrypted communication.

13. Sanitary system (200) having a sanitary fitting device (100) according to claim 1, comprising a piece of sanitary furniture (201) having an upper and a lower region (A, B), wherein an outlet and/or operating elements of the sanitary fitting (1) are arranged in the upper region (A) and the treatment device (5, 7) and in particular a mixed water device (2a, 2b) in the lower region (B).

14. Sanitary system (200) according to claim 13, characterized in that the central distribution device (6) is arranged in the lower region (B) in the center and adjacent to the upper region (A).

15. Method for operating a sanitary fitting device (100) according to claim 1, comprising the steps
providing (S1) electrical power for at least one of the treatment components (5a, 5b, 5c, 5d, 7) of the treatment device (5, 7),
measuring (S2) the electrical power which receives at least one treatment component (5a, 5b, 5c, 5d, 7),
determining (S3) whether the electrical total power of the entire electrical energy emitted by means of the central distribution device (6) lies below a specified maximum total power, and
if not, adapting (S4a) the power provided through the distribution device (6) of at least one treatment device (5a, 5b, 5c, 5d, 7), such that the specified total power is not exceeded and/or
if so, allocating (S4b) more electrical power for the at least one treatment component (5a, 5b, 5c, 5d, 7), to the extent the latter can be varied at a specified power interval at the demand of a demand device (9).
